(19) United States
(12) Patent Application Publication
(10) Pub. No.: US 2024/0277054 A1
(43) Pub. Date: Aug. 22, 2024

(54) AEROSOL GENERATING DEVICE

(71) Applicant: Nicoventures Trading Limited, London (GB)

(72) Inventors: Matthew HODGSON, London (GB); Dean COWAN, London (GB)

(21) Appl. No.: 18/571,474

(22) PCT Filed: Jun. 17, 2022
(86) PCT No.: PCT/EP2022/066613

§ 371 Date: Dec. 18, 2023

(30) Foreign Application Priority Data
Jun. 18, 2021 (GB) 2108788.7

(51) Int. Cl. A24F 40/46; A24D 1/20; A24F 40/20; A24F 40/465; H05B 3/06

(52) U.S. Cl. CPC A24F 40/46; A24D 1/20; A24F 40/20; A24F 40/465; H05B 3/06

(57) ABSTRACT

An aerosol generating device (101) is described. The device generates an aerosol from aerosol-generating material. The device has a heating zone (215) in which at least a portion of an article (110) containing aerosol-generating material is received. The device also has a heating assembly (201) comprising a heating element (320) arranged to heat the heating zone (215). A threaded arrangement (350) is in the heating zone to threadingly engage with the article when received in the heating zone.

### RELATED APPLICATIONS

The present application is a National Phase Entry of PCT Application No. PCT/EP2022/066613 filed Jun. 17, 2022, which claims priority to GB Application No. 2108788.7 filed Jun. 18, 2021, each of which is hereby incorporated by reference in their entirety.

### TECHNICAL FIELD

The present invention relates to aerosol generating device for generating an aerosol from aerosol-generating material. The present invention also relates to a system comprising an aerosol generating device and an article comprising aerosol-generating material.

### BACKGROUND

Smoking articles such as cigarettes, cigars and the like burn tobacco during use to create tobacco smoke. Attempts have been made to provide alternatives to these articles that burn tobacco by creating products that release compounds without burning. Examples of such products are heating devices which release compounds by heating, but not burning, the material. The material may be for example tobacco or other non-tobacco products, which may or may not contain nicotine.

### SUMMARY

According to an aspect, there is provided an aerosol generating device for generating an aerosol from aerosol-generating material, the device comprising a heating zone for receiving at least a portion of an article containing aerosol-generating material and a heating arrangement comprising a heating element arranged to heat the heating zone, and a threaded arrangement in the heating zone configured to threadingly engage with the article.

The threaded arrangement may comprise an internal thread arranged to threadingly engage with an outer side of the article.

The threaded arrangement may comprise an external thread arranged to threadingly engage in the article.

The heating element may comprise the threaded arrangement.

The heating element may define the heating zone.

The heating element may at least partially encircle the heating zone.

The heating element may form at least part of a receptacle defining the heating zone.

The heating element may comprise a tubular member and the threaded arrangement may comprise a thread on an inner side of the tubular member.

The heating zone may be defined around the heating element.

The heating element may protrude in the heating zone.

The threaded arrangement may comprise a shaft and a thread on the shaft.

The shaft may be tapered.

The thread may extend from a free end of the shaft.

The thread may have a constant pitch. The thread may have a constant pitch along the length of the shaft.

The thread may comprise a heat conductive material.

The thread may be heatable by penetration with the varying magnetic field in the heating zone.

The aerosol generating device may comprise an actuating mechanism configured to rotate the threaded arrangement in the heating zone.

The actuating mechanism may comprise an actuator.

The actuator may comprise an electric motor.

The actuating mechanism may be configured to rotate the threaded arrangement in the heating zone in response to insertion of an article into the heating zone.

The aerosol generating device may comprise a receptacle defining the heating zone, wherein the receptacle comprises the threaded arrangement.

The heating element may protrude in the heating zone.

The heating element may comprise a planar peripheral side.

The aerosol generating device may comprise a field generator including an inductor coil configured to generate a varying magnetic field.

The heating element may be heatable by penetration with the varying magnetic field in the heating zone.

The heating element may comprise part of a resistive heating arrangement.

According to an aspect, there is provided a heating element for heating an article containing aerosol-generating material received in a heating zone of an aerosol generating device, the heating element comprising a threaded arrangement arranged to threadingly engage with an article containing aerosol-generating material.

The heating element may comprise material heatable by penetration with a varying magnetic field.

The heating element may be a resistive heating element.

According to another aspect, there is provided a system comprising the aforementioned device and comprising an article containing aerosol-generating material.

The article may comprise an article thread configured to interact with the threaded arrangement of the device.

The article thread of the article may be an internal threaded bore.

The article thread of the article may be on an outer side of the article.

The article may comprise a pre-formed bore configured to receive the heating element.

The threaded arrangement may be configured to engage with a face of the bore.

The article may comprise an engaging feature configured to engage with the threaded arrangement.

The engaging feature may be at least one of a bore, a collar, a shoulder, a ridge, a protrusion, a recess, a lip, a chamfer, a region of increased thickness, a region of reduced thickness, a face, and an edge.

The threaded arrangement may be configured to engage with a relatively more resilient engaging feature of the article.

The threaded arrangement may be configured to engage with a relatively less resilient engaging feature of the article.

The article may comprise an outer side of the article, and the threaded arrangement may be configured to at least one of deform and distend an outer side of the article when the article is received in the heating zone.

The threaded arrangement may be configured to compress the article.

The threaded arrangement may be configured to form an indent in the outer side of the article.

The article may comprise an outer side, and the threaded arrangement may be configured to at least one of deform and distend the outer side of the article when the article is received in the heating zone. Insertion of the article may be configured to deform the threaded arrangement.

The article may be a consumable.

The heating element may be removable from the receptacle. The heating element may be interchangeable.

The heating element may upstand from a base. The heating element may comprise a sharp edge or point at a free end. The heating element may be a pin. The heating element may be configured to pierce the article received by the heating zone.

The heating element and receptacle may be co-axial.

The apparatus of this aspect can include one or more, or all, of the features described above, as appropriate.

The aerosol generating device may be a non-combustible aerosol generating device.

The device may be a tobacco heating device, also known as a heat-not-burn device.

The aerosol generating material may be non-liquid aerosol generating material.

The article may be dimensioned to be at least partially received within the heating zone.

According to an aspect, there is provided an aerosol generating device for generating an aerosol from aerosol-generating material comprising: a receptacle defining a heating zone configured to receive at least a portion of an article comprising aerosol-generating material, and a heating element arranged to heat the heating zone.

According to an aspect, there is provided an aerosol-generating system comprising an article comprising aerosol-generating material; an aerosol generating device for heating aerosol-generating material comprising a heating zone configured to receive at least a portion of the article; and a heating element.

According to an aspect, there is provided an aerosol generating device for generating an aerosol from aerosol-generating material comprising: a heating arrangement comprising: a heating element; and a threaded arrangement configured to threadingly engage with the article.

The aerosol generating device may further comprise a heating zone for receiving at least a portion of an article comprising aerosol generating material. The heating element may be arranged to heat the heating zone.

The threaded arrangement may be in the heating zone.

The threaded arrangement may be on the heating element.

The heating element may comprise a pin or blade.

At least part of the heating element may be exposed.

The aerosol generating device may further comprise a housing. The heating element may protrude from the housing.

According to an aspect, there is provided an aerosol generating system comprising the aerosol generating device of the preceding aspect and an article comprising aerosol generating material.

The article may comprise an article thread configured to interact with the threaded arrangement of the device.

The article thread of the article may be an internal threaded bore.

The article thread of the article may be on an outer side of the article.

The article may comprise a pre-formed bore configured to receive the heating element.

The threaded arrangement may be configured to engage with a face of the bore.

The article may comprise an engaging feature configured to engage with the threaded arrangement.

The engaging feature may be at least one of a bore, a collar, a shoulder, a ridge, a protrusion, a recess, a lip, a chamfer, a region of increased thickness, a region of reduced thickness, a face, and an edge.

The threaded arrangement may be configured to engage with a relatively more resilient engaging feature of the article.

The threaded arrangement may be configured to engage with a relatively less resilient engaging feature of the article.

The article may comprise an outer side of the article, and the threaded arrangement may be configured to at least one of deform and distend an outer side of the article when the article is received in the heating zone.

The threaded arrangement may be configured to compress the article.

The threaded arrangement may be configured to form an indent in the outer side of the article.

The article may comprise an outer side, and the threaded arrangement may be configured to at least one of deform and distend the outer side of the article when the article is received in the heating zone. Insertion of the article may be configured to deform the threaded arrangement.

The article may be a consumable.

The heating element may be interchangeable.

The heating element may upstand from a base. The heating element may comprise a sharp edge or point at a free end. The heating element may be a pin. The heating element may be configured to pierce the article received by the heating zone.

The heating element and receptacle may be co-axial.

The aerosol generating device may be a non-combustible aerosol generating device.

The device may be a tobacco heating device, also known as a heat-not-burn device.

The aerosol generating material may be non-liquid aerosol generating material.

According to an aspect, there is provided an aerosol generating device for generating an aerosol from aerosol-generating material, the device comprising:
a housing;
an exposed heating arrangement protruding from the housing configured to be received within an aerosol-generating article and heat the aerosol-generating article.

The heating arrangement may comprise a heating element protruding from the housing configured to be received within an aerosol-generating article.

The housing may comprise a base from which the heating element protrudes.

The device may comprise a threaded arrangement configured to threadingly engage with the article.

A heating zone may extend around the exposed heating arrangement and be configured to at least partially receive the article comprising aerosol-generating material.

According to an aspect, there is provided, an aerosol-generating system comprising: an article comprising aerosol-generating material; and an aerosol generating device for heating aerosol-generating material according to any of the above.

The apparatus of these aspects can include one or more, or all, of the features described above, as appropriate.

### BRIEF DESCRIPTION OF THE DRAWINGS

Embodiments will now be described, by way of example only, and with reference to the accompanying drawings in which:

FIG. 1 shows a front perspective view of an aerosol generating system with an aerosol generating device and an article inserted into the device;

FIG. 2 shows schematically the aerosol generating system of FIG. 1;

FIG. 3 shows schematically the aerosol generating system of FIG. 1 with a threaded arrangement;

FIG. 3a shows schematically an example of an article for use with the aerosol generating system of FIG. 3;

FIG. 3b shows schematically an example of an externally threaded article for use with the aerosol generating system of FIG. 3;

FIG. 4 shows schematically another aerosol generating system where the threaded arrangement is formed on the inner surface of a receptacle of the device;

FIG. 4a shows schematically an article with a preformed bore for use with the aerosol generating system of FIG. 4 or 5;

FIG. 5 shows schematically another aerosol generating system of FIG. 1 where an inner heating element is provided with a thread;

FIG. 5a shows schematically an internally threaded article for use with the aerosol generating system of FIG. 5;

FIG. 6 shows schematically another aerosol generating system of claim 1 where the device according to FIG. 5, comprises an actuation mechanism for rotating at least one of the receptacle and heating element;

FIG. 7 shows schematically another aerosol generating system where the threaded arrangement extends along only part of the length of the heating element;

FIG. 7a shows schematically an internally threaded article for use with the aerosol generating system of FIG. 7; and

FIG. 8 shows schematically another aerosol generating system.

### DETAILED DESCRIPTION

As used herein, the term “aerosol-generating material” is a material that is capable of generating aerosol, for example when heated, irradiated or energized in any other way. Aerosol-generating material may, for example, be in the form of a solid, liquid or gel which may or may not contain an active substance and/or flavorants. Aerosol generating material may include any plant based material, such as any tobacco-containing material and may, for example, include one or more of tobacco, tobacco derivatives, expanded tobacco, reconstituted tobacco or tobacco substitutes. Aerosol generating material also may include other, non-tobacco, products, which, depending on the product, may or may not contain nicotine. Aerosol generating material may for example be in the form of a solid, a liquid, a gel, a wax or the like. Aerosol generating material may for example also be a combination or a blend of materials. Aerosol generating material may also be known as “smokable material”.

The aerosol-generating material may comprise a binder and an aerosol former. Optionally, an active and/or filler may also be present. Optionally, a solvent, such as water, is also present and one or more other components of the aerosol-generating material may or may not be soluble in the solvent. In some embodiments, the aerosol-generating material is substantially free from botanical material. In some embodiments, the aerosol-generating material is substantially tobacco free.

The aerosol-generating material may comprise or be an “amorphous solid”. The amorphous solid may be a “monolithic solid”. In some embodiments, the amorphous solid may be a dried gel. The amorphous solid is a solid material that may retain some fluid, such as liquid, within it. In some embodiments, the aerosol-generating material may, for example, comprise from about 50 wt %, 60 wt % or 70 wt % of amorphous solid, to about 90 wt %, 95 wt % or 100 wt % of amorphous solid.

The aerosol-generating material may comprise an aerosol-generating film. The aerosol-generating film may comprise or be a sheet, which may optionally be shredded to form a shredded sheet. The aerosol-generating sheet or shredded sheet may be substantially tobacco free.

Apparatus is known that heats aerosol generating material to volatilise at least one component of the aerosol generating material, typically to form an aerosol which can be inhaled, without burning or combusting the aerosol generating material. Such apparatus is sometimes described as an “aerosol generating device”, an “aerosol provision device”, a “heat-not-burn device”, a “tobacco heating product device” or a “tobacco heating device” or similar. Similarly, there are also so-called e-cigarette devices, which typically vaporize an aerosol generating material in the form of a liquid, which may or may not contain nicotine. The aerosol generating material may be in the form of or be provided as part of a rod, cartridge or cassette or the like which can be inserted into the apparatus. A heater for heating and volatilising the aerosol generating material may be provided as a “permanent” part of the apparatus.

An aerosol generating device can receive an article comprising aerosol generating material for heating. An “article” in this context is a component that includes or contains in use the aerosol generating material, which is heated to volatilize the aerosol generating material, and optionally other components in use. A user may insert the article into the aerosol provision device before it is heated to produce an aerosol, which the user subsequently inhales. The article may be, for example, of a predetermined or specific size that is configured to be placed within a heating chamber of the device which is sized to receive the article.

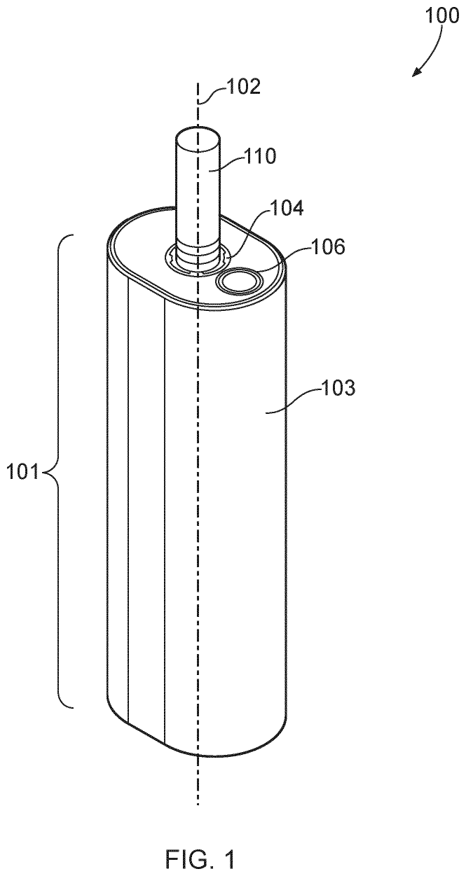

FIG. 1 shows an example of an aerosol generating system 100. The system 100 comprises an aerosol generating device 101 for generating aerosol from an aerosol generating material, and a replaceable article 110 comprising the aerosol generating material. The device 101 can be used to heat the replaceable article 110 comprising the aerosol generating material, to generate an aerosol or other inhalable material which can be inhaled by a user of the device 101.

The device 101 comprises a housing 103 which surrounds and houses various components of the device 101. The housing 103 is elongate. The device 101 has an opening 104 in one end, through which the article 110 can be inserted for heating by the device 101. The article 110 may be fully or partially inserted into the device 101 for heating by the device 101.

In various embodiments, the device 101 is free from an opening. In such an arrangement, the device 101, or a component of, may be partially received within at least a portion of the article 110.

The device 101 may comprise a user-operable control element 106, such as a button or switch, which operates the device 101 when operated, e.g. pressed. For example, a user may activate the device 101 by pressing the switch 106.

The device 101 defines a longitudinal axis 102, along which an article 110 may extend when inserted into the device 101. The opening 104 is aligned on the longitudinal axis 102.

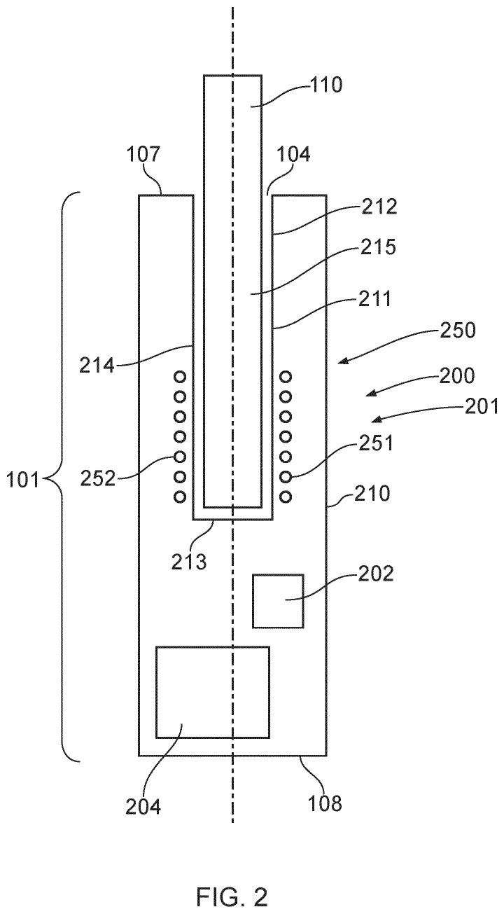

FIG. 2 is a schematic illustration of the aerosol generating system 100 of FIG. 1, showing various components of the device 101. It will be appreciated that the device 101 may include other components not shown in FIG. 2 and that some components shown in FIG. 2 may not be present in some embodiments.

As shown in FIG. 2, the device 101 includes an apparatus for heating aerosol-generating material 200. The apparatus 200 includes a heating assembly 201, a controller (control circuit) 202, and a power source 204. The apparatus 200 comprises a body assembly 210. The body assembly 210 may include a chassis and other components forming part of the device. The heating assembly 201 is configured to heat the aerosol-generating material of an article 110 inserted into the device 101, such that an aerosol is generated from the aerosol generating material. The power source 204 supplies electrical power to the heating assembly 201, and the heating assembly 201 converts the supplied electrical energy into heat energy for heating the aerosol-generating material.

The power source 204 may be, for example, a battery, such as a rechargeable battery or a non-rechargeable battery. Examples of suitable batteries include, for example, a lithium battery (such as a lithium-ion battery), a nickel battery (such as a nickel-cadmium battery), and an alkaline battery.

The power source 204 may be electrically coupled to the heating assembly 201 to supply electrical power when required and under control of the controller 202 to heat the aerosol generating material. The control circuit 202 may be configured to activate and deactivate the heating assembly 201 based on a user operating the control element 106. For example, the controller 202 may activate the heating assembly 201 in response to a user operating the switch 106.

The end of the device 101 closest to the opening 104 may be known as the proximal end (or mouth end) 107 of the device 101 because, in use, it is closest to the mouth of the user. In use, a user inserts an article 110 into the opening 104, operates the user control 106 to begin heating the aerosol generating material and draws on the aerosol generated in the device. This causes the aerosol to flow through the article 110 along a flow path towards the proximal end of the device 101.

The other end of the device furthest away from the opening 104 may be known as the distal end 108 of the device 101 because, in use, it is the end furthest away from the mouth of the user. As a user draws on the aerosol generated in the device, the aerosol flows in a direction towards the proximal end of the device 101. The terms proximal and distal as applied to features of the device 101 will be described by reference to the relative positioning of such features with respect to each other in a proximal-distal direction along the axis 102.

The heating assembly 201 may comprise various components to heat the aerosol generating material of the article 110 via an inductive heating process or a resistive heating process, for example. Induction heating is a process of heating an electrically conducting heating element (such as a susceptor) by electromagnetic induction. An induction heating assembly may comprise an inductive element, for example, one or more inductor coils, and a device for passing a varying electric current, such as an alternating electric current, through the inductive element. The varying electric current in the inductive element produces a varying magnetic field. The varying magnetic field penetrates a susceptor suitably positioned with respect to the inductive element, and generates eddy currents inside the susceptor. The susceptor has electrical resistance to the eddy currents, and hence the flow of the eddy currents against this resistance causes the susceptor to be heated by Joule heating. In cases where the susceptor comprises ferromagnetic material such as iron, nickel or cobalt, heat may also be generated by magnetic hysteresis losses in the susceptor, i.e. by the varying orientation of magnetic dipoles in the magnetic material as a result of their alignment with the varying magnetic field. In inductive heating, as compared to heating by conduction for example, heat is generated inside the susceptor, allowing for rapid heating. Further, there need not be any physical contact between the inductive element and the susceptor, allowing for enhanced freedom in construction and application. Resistive heating instead utilizes the Joule heating effect arising from the electrical resistance of a material in response to application of a current directly therethrough.

The apparatus 200 includes a heating chamber 211 configured and dimensioned to receive the article 110 to be heated. The heating chamber 211 defines a heating zone 215. In the present example, the article 110 is generally cylindrical, and the heating chamber 211 is correspondingly generally cylindrical in shape. However, other shapes would be possible. The heating chamber 211 is formed by a receptacle 212. The receptacle 212 includes an end wall 213 and a peripheral wall 214. The end wall 213 acts as a base of the receptacle 212. The receptacle 212 in embodiments is a one-piece component. As used herein, the term ‘one-piece component’ is intended to mean that the features are formed together such that no joints are defined therebetween. In other embodiments the receptacle 212 comprises two or more components.

The heating chamber 211 is defined by the inner surfaces of the receptacle 212. The receptacle 212 acts as a support member. The receptacle 212 comprises a generally tubular member. The receptacle 212 extends along and around and substantially coaxial with the longitudinal axis 102 of the device 101. However, other shapes would be possible. The receptacle 212 (and so heating zone 215) is open at its proximal end such that an article 110 inserted into the opening 104 of the device 101 can be received by the heating chamber 211 therethrough. The receptacle 212 is closed at its distal end by the end wall 213. The receptacle 212 may comprise one or more conduits that form part of an air path. In use, the distal end of the article 110 may be positioned in proximity or engagement with the end of the heating chamber 211. Air may pass through the one or more conduits forming part of the air path, into the heating chamber 211, and flow through the article 110 towards the proximal end of the device 101.

The receptacle 212 may be formed from an insulating material. For example, the receptacle 212 may be formed from a plastic, such as polyether ether ketone (PEEK). Other suitable materials are possible. The receptacle 212 may be formed from such materials ensure that the assembly remains rigid/solid when the heating assembly 201 is operated. Using a non-metallic material for the receptacle 212 may assist with restricting heating of other components of the device 101. The receptacle 212 may be formed from a rigid material to aid support of other components.

Other arrangements for the receptacle 212 would be possible. For example, in an embodiment the end wall 213 is defined by part of the heating assembly 201. In embodiments, the receptacle 212 comprises material that is heatable by penetration with a varying magnetic field. In some embodiments, the receptacle 212 comprises a material heatable by resistive Joule heating.

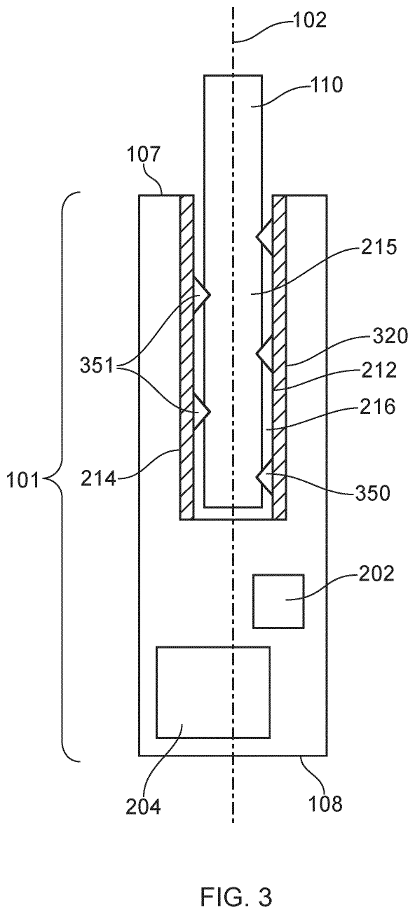

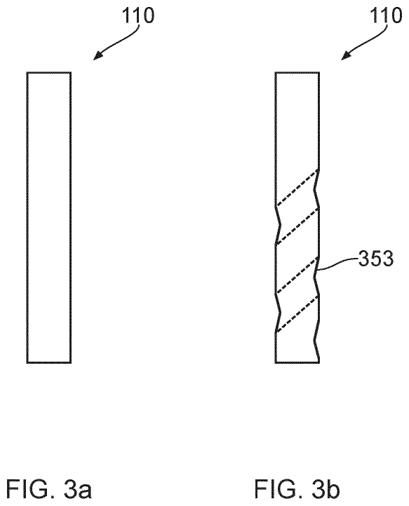

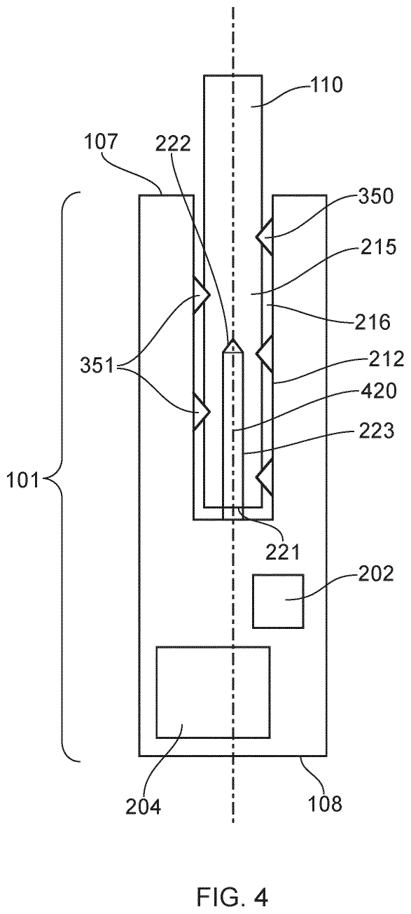

As illustrated in FIG. 3, the heating assembly 201 may comprise a heating element 320 positioned surrounding the heating zone 215. In such an arrangement, the heating element 320 forms the receptacle 212. The heating element 320 defines the peripheral wall 214. The heating element 320 is configured to heat the heating zone 215. The heating zone 215 is defined in the heating chamber 211. In embodiments the heating chamber 211 defines a portion of the heating zone 215 or the extent of the heating zone 215.

The heating zone 215 is a zone or volume into which an article may be received for heating by the device. The heating zone 215 is defined therefore at least in part by the heating assembly 201. The heating zone 215 is a space adjacent to the heating element 220. In embodiments comprising the heating chamber 211, such as shown in FIG. 3, the heating chamber 211 delimits the heating zone 215. That is, the heating element 320 defines the heating zone 215. In embodiments, the heating element 220 defines the heating zone without a heating chamber.

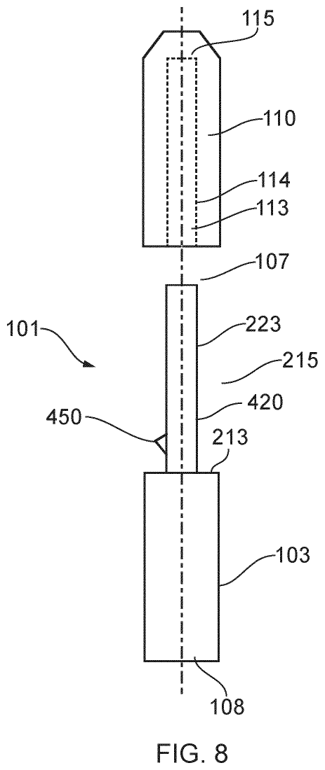

As described below, for example with reference to FIG. 8, in various embodiments the apparatus 200 is free from a heating chamber. The heating element protrudes from the housing 103. In such embodiments, the receptacle and heating chamber may be omitted, and the heating element may be surrounded by free space. The heating element, or at least part of the heating element, is free from being surrounded by a peripheral member, such as a peripheral wall of the device when the article is on the heating element. The term ‘heating zone’ will be understood to include a space surrounding the heating element. That is, the heating zone may not be delimited or surrounded by a component of the device.

The heating element 320 is heatable to heat the heating zone 215. The heating element 320 may be an induction heating element or a resistive heating element. That is, the heating element 320 may comprise a susceptor that is heatable by penetration with a varying magnetic field or a resistive material heatable by passing a current directly therethrough from a power source. If the heating member 320 comprises a susceptor, the susceptor comprises electrically conducting material suitable for heating by electromagnetic induction. For example, the susceptor may be formed from a carbon steel. It will be understood that other suitable materials may be used, for example a ferromagnetic material such as iron, nickel or cobalt.

As shown in FIG. 2, the heating assembly 201 comprises a magnetic field generator 250. The magnetic field generator 250 is configured to generate one or more varying magnetic fields that penetrate the heating element 320 so as to cause heating in the heating element 320. The magnetic field generator 250 includes an inductor coil arrangement 251. The inductor coil arrangement comprises an inductor coil 252, acting as an inductor element. The inductor coil 252 may be a helical coil, however other arrangements are envisaged. In embodiments, the inductor coil arrangement 251 comprises two or more inductor coils. The two or more inductor coils in embodiments are disposed adjacent to each other and may be aligned co-axially along the axis.

In some examples, in use, the magnetic field generator 250 is configured to heat the heating element 320 to a temperature of between about 200° C. and about 350° C., such as between about 240° C. and about 300° ° C., or between about 250° C. and about 280° ° C. In examples where the heating element is a resistive heating element, similar or the same temperatures may be reached by resistive heating therein.

The inductor coil 252 may be a helical coil comprising electrically-conductive material, such as copper. The coil is formed from wire, such as Litz wire, which is wound helically around a support member (not shown). The support member is formed by the receptacle 212 or by another component. In embodiments, the support member is omitted. The support member is tubular. The coil 252 defines a generally tubular shape. The inductor coil has a generally circular profile. In other embodiments, the inductor coil may have a different shape, such as generally square, rectangular or elliptical. The coil width may increase or decrease along its length.

Other types of inductor coil may be used, for example a flat spiral coil. With a helical coil it is possible to define an elongate inductor zone in which to receive a susceptor, which provides an elongate length of susceptor to be received in the elongate inductor zone. The length of susceptor subjected to varying magnetic field may be maximized. By providing an enclosed inductor zone with a helical coil arrangement it is possible to aid the flux concentration of the magnetic field.

Litz wire comprises a plurality of individual wires which are individually insulated and are twisted together to form a single wire. Litz wires are designed to reduce the skin effect losses in a conductor. Other wire types could be used, such as solid. The configuration of the helical inductor coil may vary along its axial length. For example, the inductor coil, or each inductor coil, may have substantially the same or different values of inductance, axial lengths, radii, pitches, numbers of turns, etc.

In embodiments, the heating element forms part of a heating arrangement. The heating arrangement comprises the heating element protruding from the base. In other embodiments, the heating element is in the article, and the heating arrangement comprises a protruding member protruding from the base. The heating element or protruding member in embodiments comprises the magnetic field generator configured to generate a varying magnetic field including an inductor coil. The heating arrangement in embodiments is an inductive heating arrangement. The heating arrangement in embodiments is a resistive heating arrangement.

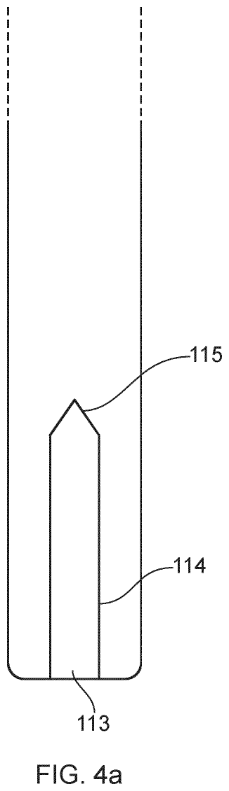

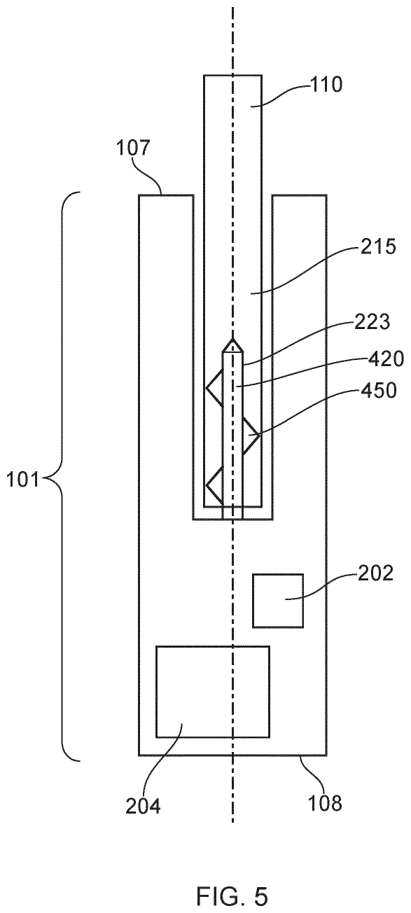

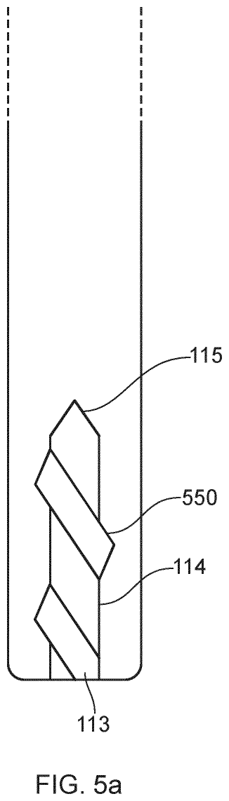

In embodiments, such as that shown in FIGS. 4 and 5, the heating element 420 extends in the heating zone 215. The heating element 420, acting as a protruding element, protrudes in the heating zone 215. The heating element 420 upstands from the base.

In embodiments, the base is formed by a feature other than the end wall 213 of the receptacle.

The heating element 420 is spaced from the peripheral wall 214. The heating assembly 201 is configured such that when an article 110 is received by the heating chamber 211, the heating element 420 extends into a distal end of the article 110. The heating element 420 is positioned, in use, within the article 110. The heating element 420 is configured to heat aerosol generating material of an article 110 from within, and for this reason is referred to as an inner heating element.

The heating element 420 extends into the heating chamber 211 from the distal end of the heating chamber 211 along the longitudinal axis 102 of the device (in the axial direction). In embodiments the heating element 420 extends into the heating chamber 211 spaced from the axis 102. The heating element 420 may be off-axis or non-parallel to the axis 102. Although one heating element 420 is shown, it will be understood that in embodiments, the heating assembly 201 comprises a plurality of heating elements 420. Such heating elements in embodiments are spaced from but parallel to each other.

When the heating element 320, 420 of any of the described embodiments utilizes heating via magnetic susceptibility, the inductor coil 252 may be disposed external to the receptacle 212. The inductor coil may encircle the heating zone 215. The helical inductor coil may extend around at least a portion of the heating element 320, 420, acting as a susceptor. The helical inductor coil is configured to generate a varying magnetic field that penetrates the heating element 320, 420. The helical inductor coil is arranged coaxially with the heating chamber 211 and longitudinal axis 102.

Although the illustrated embodiments show devices including either a heating element 320 disposed around the heating zone 215 and at least one heating element 420 disposed within the heating zone 215, any of the described embodiments may utilize both a heating element 320 surrounding the heating zone 215 and one or more heating elements 420 within the heating zone 215.

The heating element 420 protrudes in the heating zone 215 and is received by the article 110. FIG. 2 shows the article 110 received in the device 101. The article 110 is sized to be received by the receptacle 212. The outer dimensions of the article 110 perpendicular to the longitudinal axis of the article 110 substantially correspond with the inner dimensions of the chamber 211 perpendicular to the longitudinal axis 102 of the device 101 to allow insertion of the article 110 into the receptacle 212. In embodiments, a gap 216 is defined between an outer side 111 of the article 110 and an inner side 217 of the receptacle 212. The gap 216 may act as an air passage along at least part of the axial length of the chamber 211. An insertion end 112 of the article 110 is arranged to lie adjacent to the base of the receptacle 212.

FIG. 2 illustrates a basic structure of the device 101. Particular features are omitted in this figure such as the threaded arrangement, as the various envisaged configurations of these will be discussed in terms of the embodiments shown in FIGS. 3 to 5. FIG. 2 does however generally show an article 110 disposed within the heating zone 215 of a device 101. This is an in-use configuration in which the aerosol-generating material in the article may be heated and a user may draw the aerosolized material from the article/device.

FIG. 3 illustrates an arrangement of the device 101. As can be seen, the receptacle 212 comprises a threaded arrangement 350. The threaded arrangement 350, in this embodiment, comprises a thread 351 disposed on the inner surface of the receptacle 212. The thread is helical. Although the pitch of the threaded arrangement 350 is shown in this figure as being rather large, such that the entire threaded arrangement 350 comprises around 2 or 3 turns (turn count) along the length of the receptacle 212, any particular pitch or number of turns for any of the threaded arrangements described herein are envisaged. Generally, a higher pitch, and therefore lower thread count along the length of the threaded arrangement minimizes the number of rotations required upon insertion thereof into the device. In some embodiments, the turn count of the threaded arrangement is between 1 and 5. In FIG. 3, the heating element 320 is positioned surrounding the heating zone 215. This means that the article 110 is heated from the outside. Although the threaded arrangement 350 of FIG. 3 extends along the length of the receptacle 212, in embodiments, the threaded arrangement 350 may extend along only part of the length of the receptacle 212 or heating element 320.

The threaded arrangement 350 in embodiments forms part of the heating element 320 or may a component placed in proximity to the heating element 320. When the threaded arrangement 350 is part of the heating element 320, or is otherwise thermally conductive, the threads 351 of the threaded arrangement 350 increase the surface area of the article 110 in contact with, or in proximity to, the heating element 320. This helps increase the rate of heating of the article 110 in use, thereby resulting in faster aerosolization of the material in the article 110, a greater aerosolization effect, and greater overall efficiency of the device. In addition, the provision of the threaded arrangement ensures that the article 110 can be simply and securely inserted into the device 101.

FIG. 3a shows an example of an article 110 for use with the device 101 of any of the embodiments described herein. As can be seen, the article 110 is generally cylindrical in shape, although other shapes are envisaged. The article 110 of FIG. 3a is generally malleable to the extent that, when driven into the heating zone 215 into engagement with the threaded arrangement 350, the thread 351 deforms and/or distends the article 110 such that the threads 315 increase their contact surface area with the article 110 and the aerosol-generating material thereof. As mentioned above, this increased contact surface area increases the aerosolization effect of the device 101.

FIG. 3b shows an example of an article 110 for use with the device 101 of FIG. 3, or any other contemplated device 101 also including an internally threaded receptacle 212. As can be seen in the figure, the article 110 is provided with an external thread 353. External thread 353 is configured to match the threading arrangement 350 disposed on the internal surface of the receptacle 212 such that the article 110 may be more easily and precisely screwed into the heating zone 215 of the device 101 in use. Less malleable articles may be used with such external threads. The use of an external thread may also provide for a more secure placement of the article in the device, as well as also providing an increased contact surface area or thermal path between the heating element 320 and the article 110.

FIG. 4 shows a further embodiment of the present invention. In this embodiment, the receptacle 212 is again provided with a threaded arrangement 350 on its internal surface. The threaded arrangement 350 is generally the same as the arrangement 350 described in relation to FIG. 3. In this embodiment, however, the receptacle 212 and the threaded arrangement 350 are free from heating material. Both articles 110 of FIGS. 3a and 3b may be used with the device 101 of FIG. 4. The device 101 of FIG. 4 differs from that of FIG. 3 in that the heating element 420 is instead disposed internally to the heating zone 215.

The heating element 420 defines the heating zone 215. The receptacle 212 delimits the heating zone 215.

The heating element 420 is in the form of a pin and is configured to pierce the article 110 in use. As can be seen from the figure, the free end 222 of the heating element 420 is provided with a spike in order to facilitate insertion of the element 420 into the article 110. In this embodiment, the heating element is a straight pin. The outer side of the pin is cylindrical. The heating element 420 is free from a threaded arrangement. The downward pressure of the article 110 onto the heating element 420 pierces and is subsequently embedded in the article 110. The heating element 420, by inductive or resistive heating, is configured to produce heat and heat the contents of the article 110 from the inside, thereby aerosolising the aerosol-generating material therewithin. In this embodiment, the threaded arrangement 350 on the internal surface of the receptacle not only provides a more secure positioning of the article 110 in the heating zone 215, but aids in providing the necessary force to pierce the article 110 with the heating element 420. Rotational motion of the article 110 is translated into linear motion by the threaded arrangement 350, which drives the article 110 onto the pin of the heating element 420. This may prevent breakage or damage of the article 110 as compared to known devices, which may be caused by an excessive direct linear downward force exerted on the article 110 by the user to push the article 110 onto the heating element 420.

Although not shown, one embodiment of the invention involves a combination of the embodiments of FIG. 3 and FIG. 4. That is to say, one embodiment of the device 101, with the threaded arrangement 350, includes both a heating element 320 disposed around the heating zone 215 and a heating element 420 protruding in the heating zone 215. Any of the embodiments with an internal heating element 420 may comprise multiply internal heating elements 420. Including both external and internal heating elements increases the heating effect of the article 110, including providing faster heating and a better heat distribution through the article 110.

FIG. 4a shows an example of an article 110 for use with any of the embodiments of the present invention, but particularly those of FIGS. 4 and 5, which comprise an inner pin-shaped heating element 420 protruding in the heating zone 215. The article 110 shown in this figure comprises an internal bore 113 with inner bore surface 114. The bore 113 is pre-formed in the article 110. The bore 113 is formed in embodiments by a tubular portion of the article 110. The bore 113 in embodiments extends partially along the longitudinal axis of the article. The bore 113 has a closed end 115. The heating element 420 is sized to be received in the bore 113. The heating element 420 and bore 113 are complimentary sized. The provision of a bore 113 in general facilitates the insertion of a pin heating element 420 into the article 110. The inner surface 114 of the bore is configured to form a close contact with the heating element to maximize heat transfer between the heating element 420 and the article 110.

In embodiments the outer dimensions of the heating element are greater than those of the bore. In such arrangements, the heating element is configured to deform and/or distend the article 110 to be inserted into the article 110. To facilitate this, the inner heating element 420 is configured to pierce an article 110 that is inserted into the device 101. In such an embodiment, the free end 222 of the heating element 420 comprises a sharp edge or point. The free end 222 of the heating element 420 in embodiments comprises a sharp edge, point or other guide feature to aid location of the heating element 420 in the article 110.

The article 110 shown in FIG. 4a is envisaged to be used with any of the embodiments described herein comprising such an internal heating element 420.

FIG. 5 shows a further embodiment of the invention. In this embodiment, an internal pin heating element 420 is provided. The heating element 420 is provided with a threaded arrangement 450 on its outer surface 223. The threaded arrangement 450 may form part of the heating element 420 or be otherwise thermally conductive. Similar to the threaded arrangement 350 of aforementioned embodiments, the threaded arrangement 450 increases the contact surface area or thermal path between the heating element 420 and the article 110, thereby increasing the heating effect of the heating element 420 on the article 110. The heating element 420 is formed with a shaft and a thread on the shaft. In embodiments the shaft is tapered. The shaft in embodiments is tapered to the free end of the heating element. In embodiments the thread 450 extends to the free end of the heating element.

The heating element 420 may further be provided with a spike on its free end 222 to ease insertion. In use the article 110 is rotated onto the threaded arrangement 450 of the heating element 420 which allows the heating element 420 to pierce the article 110. Although not shown, in any of the described embodiments, a heating element 320 may also be disposed surrounding the heating zone 215 in order to increase heating distribution and power. In addition, although not shown in any of the figures, any embodiment of the invention may include an externally threaded pin heating element 420 as shown in FIG. 5 and also an internally threaded receptacle 212 defining the heating zone as shown in FIG. 3. The combination of these threaded arrangements on the receptacle 212 and the heating element 420 further increase the secure fit, ease of insertion, increased heating effectiveness and overall device efficiency associated with each individual embodiment.

FIG. 5a shows an example of an article 110 for use with any of the embodiments of the present invention. The article 110 of FIG. 5a is generally the same as the article 110 of FIG. 4a, apart from the bore 113 of the article 110 of FIG. 5a is provided with a threaded arrangement 550. Providing the bore 113 with a threaded arrangement 550, which matches a threaded arrangement 450 on the outer surface of an internal heating element 420, further improves the ease of insertion of the heating element 420 into the article 110 and also the contact surface area or thermal path between the heating element 420 and the article 110. As compared with articles 110 with no bore 113, or a straight sided bore 113, the article 110 of FIG. 5a with a threaded arrangement 550 may be employed to enable articles 110 with less malleability to be used in devices 101 as described in the present invention.

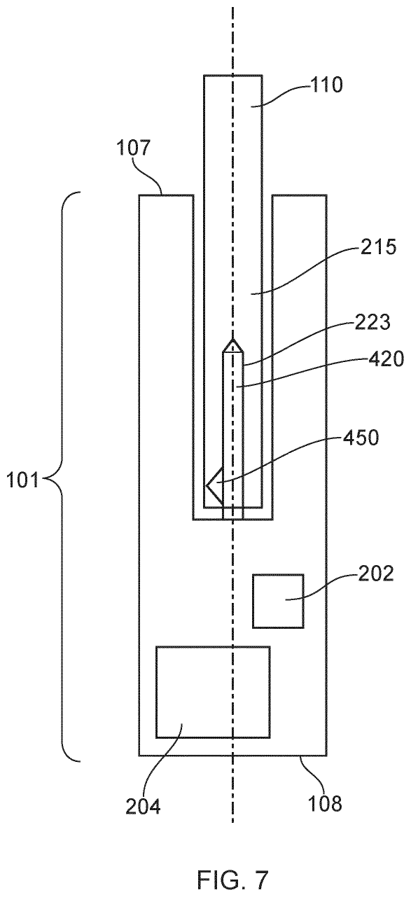

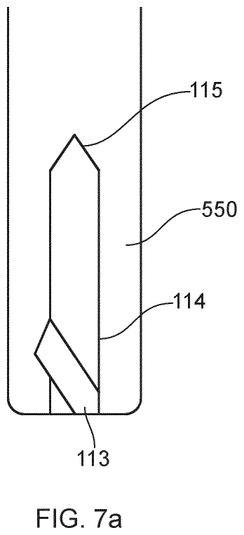

FIG. 7 shows another embodiment. The embodiment of FIG. 7 generally corresponds to that of FIG. 5, except that the threaded arrangement 450 extends partially along the heating element 420. A portion of the axial length of the heating element 420 is free from a threaded arrangement.

In the embodiment of FIG. 7, the threaded arrangement 450 is disposed adjacent to the base of the heating element 420. This allows close contact of the heating element 420 with the bore 113 of the article, as the bore 113 does not need accommodate the threaded arrangement 450 to travel up the bore 113. That is, a portion of the heating element 420 which is free from the threaded arrangement 450 may contact the inner bore surface 114. In embodiments, the threaded arrangement 450 may be disposed part way along the heating element 420 or adjacent to the proximal end of the heating element 420. Similar to the threaded arrangement 350 of aforementioned embodiments, the threaded arrangement 450 increases the contact surface area or thermal path between the heating element 420 and the article 110, thereby increasing the heating effect of the heating element 420 on the article 110.

The heating element 420 is formed with a shaft and a thread on the shaft. In embodiments the shaft is tapered. The shaft in embodiments is tapered to the free end of the heating element. In this embodiment, the number of times that the article must be fully rotated in order for it to engage with the thread during insertion into the device is reduced, thereby facilitating user interaction. Device complexity and/or weight may also be reduced relative to embodiments in which the thread extends the full length of the heating element or receptacle, while at the same time still providing a secure engagement between the article and the device.

FIG. 7a shows an example of an article 110 for use with any of the embodiments of the present invention. The article 110 of FIG. 7a is generally the same as the article 110 of FIG. 4a, apart from that the threaded arrangement 550 extends only part way along the bore 113 of the article 110. The article 110 of FIG. 7a may be used with the aerosol generating device 101 of FIG. 7.

As discussed above, embodiments are envisaged in which the threaded arrangement 350 partially extends along the receptacle 212. For example, the embodiments of FIGS. 3 and 4 may comprise a threaded arrangement which extends partially along the receptacle. That is, a portion of the axial length of the receptacle 212 may be free from the threaded arrangement 350. As with the embodiment of FIG. 7, the threaded arrangement 350 may be disposed adjacent to the base of the heating receptacle 212. In embodiments, the threaded arrangement 350 may be disposed part way along the receptacle 212 or adjacent to the proximal end of the receptacle 212.

FIG. 8 shows another embodiment. The embodiment of FIG. 8 corresponds to that of FIG. 5, except that the heating element 420 protrudes from the housing 103. In such an embodiment, the device is free from a receptacle in which the heating element is received. That is, the heating zone 215 is free from being surrounded or delimited by any other component.

The housing 103 defines the base 213 from which the heating element 220 protrudes. The heating element 220 upstands from the base 213. The heating element 220 is configured to receive at least a portion of the article 110.

The heating element 420 is exposed. The term ‘exposed’ will be understood to mean that a portion of a feature is not surrounded by another feature such that the feature extends beyond an external extent. The heating element 220 is not received in a heating chamber. With the device of FIG. 2A, the heating element extends beyond an external extent of the housing of the device. In the embodiment of FIG. 8, the entire heating element 420 protruding from the base is free from being surrounded. In embodiments, a substantial portion of the heating element 220 is exposed. In such an embodiment, a minor portion of the heating element extends within the external extent of the housing of the device. Optionally, at least 80% of the heating element 220 is exposed, optionally 60%, and optionally 50%.

In embodiments the base may comprise a recess. The heating element 220 in such embodiments may protrude from the recess. An end of the article may extend in the recess. The threaded arrangement 350 may be in the recess. For example, the threaded arrangement in embodiments is on a side wall of the recess. Similar to the threaded arrangement 350 of aforementioned embodiments, the threaded arrangement 450 increases the contact surface area or thermal path between the heating element 420 and the article 110, thereby increasing the heating effect of the heating element 420 on the article 110. The heating element 420 is formed with a shaft and a thread on the shaft. In embodiments the shaft is tapered. The shaft in embodiments is tapered to the free end of the heating element.

In embodiments, a substantial portion of the heating element 420 is exposed. In such an embodiment, a minor portion of the heating element extends within the external extent of the housing of the device. Optionally, at least 80% of the heating element 220 is exposed, optionally 60%, and optionally 50%.

The heating arrangement in embodiments is an inductive heating arrangement. The inductive coil may extend in the heating element 420. The heating arrangement in embodiments is a resistive heating arrangement.

FIG. 8 also shows an article 110 for use with any of the embodiments described herein. The article 110 of FIG. 8 is generally the same as the article 110 of FIG. 4a. The article 110 of FIG. 8 may be used with the aerosol generating device 101 of FIG. 8.

Any combination of the aforementioned features relating to each embodiment, such as the external and internal heating elements 320 and 420, the threaded arrangements 350 and 450 on said heating elements, the internal and external threaded arrangements 353 and 550 of the article, and/or the straight-sided internal bore 113 of the article, is contemplated.

Although the heating elements 320 and 420 and the threaded arrangements 350 and 450 thereon have generally been represented as being constant in diameter, in some embodiments, the heating elements may be tapered along their length (along the longitudinal axis 102). A tapered internal pin heating element 420 may further aid in the insertion thereof into an article 110 in use.

In any of the embodiments comprising a heating element 420 internal to the heating chamber 215 comprising an external threaded arrangement 450, the device 101 may further comprise a manual or motorized means of rotating the heating element 420 and/or receptacle 212 with the threaded arrangement 350, 450 with respect to the heating zone 215 and an inserted article. The heating element 420 and/or threaded arrangement 450 may be configured to automatically rotate upon insertion of the article 110, such as by detection of pressure on the device 101 from the article 110. Motorized rotation, via an included actuation mechanism, of the threaded arrangement 450 and/or heating element 420 aids the user in driving the article 110 onto the heating element 450 in the heating zone 215.

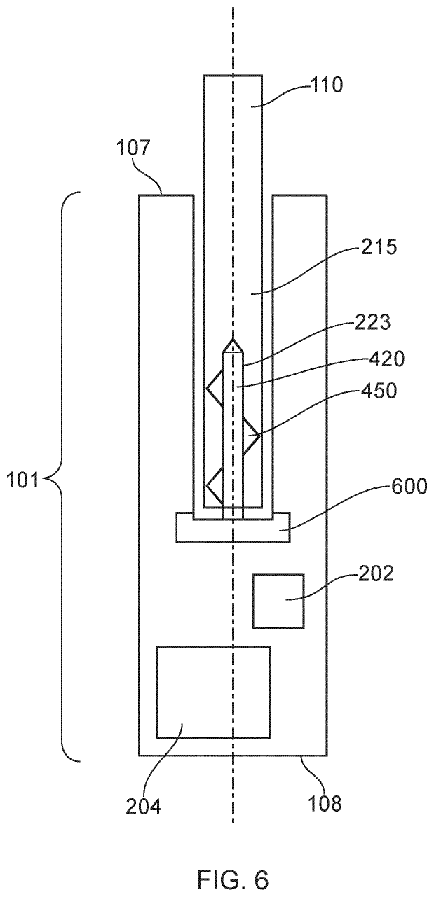

FIG. 6 shows an embodiment of the device 101 including an actuation mechanism 600. As described above, the actuation mechanism 600 may be configured to drive rotation of the heating element 420 and/or receptacle 212 with the threaded arrangement 350, 450 with respect to the heating zone 215. The actuation mechanism 600 may be powered by power source 204 and may be activated via a switch or automatically upon detection/insertion of an article 110 in the heating zone 215. Since the actuation mechanism 600 may be configured to rotate one or both of the receptacle 212 and the heating element 420, it may be included in any of the embodiments described herein.

In some of the above described embodiments, the heating arrangement is an inductive heating arrangement. In other embodiments, other types of heating arrangement are used, such as resistive heating. The configuration of the device is generally as described above and so a detailed description will be omitted. In such arrangements the heating assembly 201 comprises a resistive heating generator including components to heat the heating element via a resistive heating process. In this case, an electrical current is directly applied to a resistive heating component, and the resulting flow of current in the heating component causes the heating component to be heated by Joule heating. The resistive heating component comprises resistive material configured to generate heat when a suitable electrical current passes through it, and the heating assembly 201 comprises electrical contacts for supplying electrical current to the resistive material.

In embodiments, the heating element forms the resistive heating component itself. In embodiments the resistive heating component transfers heat to the heating element, for example by conduction.

The above embodiments are to be understood as illustrative examples of the invention. Further embodiments of the invention are envisaged. It is to be understood that any feature described in relation to any one embodiment may be used alone, or in combination with other features described, and may also be used in combination with one or more features of any other of the embodiments, or any combination of any other of the embodiments. Furthermore, equivalents and modifications not described above may also be employed without departing from the scope of the invention, which is defined in the accompanying claims.

1. An aerosol generating device for generating an aerosol from aerosol-generating material comprising:
a heating zone for receiving at least a portion of an article containing aerosol-generating material;
a heating arrangement comprising:
a heating element arranged to heat the heating zone; and
a threaded arrangement in the heating zone configured to threadingly engage with the article.

2. The aerosol generating device of claim 1, wherein the threaded arrangement comprises an internal thread arranged to threadingly engage with an outer side of the article.

3. The aerosol generating device of claim 1, wherein the threaded arrangement comprises an external thread arranged to threadingly engage in the article.

4. The aerosol generating device of claim 1, wherein the heating element comprises the threaded arrangement.

5. The aerosol generating device of claim 4, wherein the heating element defines the heating zone.

6. The aerosol generating device of claim 4, wherein the heating element at least partially encircles the heating zone.

7. The aerosol generating device of claim 6, wherein the heating element forms at least part of a receptacle defining the heating zone.

8. The aerosol generating device of claim 7, wherein the heating element comprises a tubular member and the threaded arrangement comprises a thread on an inner side of the tubular member.

9. (canceled)

10. The aerosol generating device of claim 4, wherein the heating element protrudes in the heating zone.

11. The aerosol generating device of claim 10, wherein the threaded arrangement comprises a shaft and a thread on the shaft.

12. (canceled)

13. (canceled)

14. (canceled)

15. (canceled)

16. (canceled)

17. The aerosol generating device of claim 1, comprising an actuating mechanism configured to rotate the threaded arrangement in the heating zone.

18. (canceled)

19. (canceled)

20. (canceled)

21. (canceled)

22. (canceled)

23. (canceled)

24. (canceled)

25. (canceled)

26. (canceled)

27. (canceled)

28. (canceled)

29. (canceled)

30. (canceled)

31. (canceled)

32. An aerosol generating device for generating an aerosol from aerosol-generating material comprising:
a heating arrangement comprising:
a heating element; and
a threaded arrangement configured to threadingly engage with an article.

33. The aerosol generating device of claim 32, comprising a heating zone for receiving at least a portion of the article comprising aerosol generating material, wherein the heating element is arranged to heat the heating zone.

34. The aerosol generating device of claim 33, wherein the threaded arrangement is in the heating zone.

35. The aerosol generating device of claim 32, wherein the threaded arrangement is on the heating element.

36. The aerosol generating device of claim 32, wherein at least part of the heating element is exposed.

37. (canceled)

38. An aerosol generating system comprising the aerosol generating device of claim 32 and the article containing an aerosol generating material.

39. The system of claim 38, wherein the article comprises an article thread configured to interact with the threaded arrangement of the device.

40. The system of claim 39, wherein the article thread of the article is an internal threaded bore.

41. The system of claim 39, wherein the article thread of the article is on an outer side of the article.
